(19) United States
(12) Patent Application Publication
(10) Pub. No.: US 2026/0370917 A1
(43) Pub. Date: Nov. 19, 2026

(54) UPDATING NETWORK TRAFFIC DATA ACQUISITION PARAMETERS OF A STREAMING METER DEVICE BASED ON APPLICATION-LEVEL PARENTAL CONTROL RESTRICTIONS

(71) Applicant: The Nielsen Company (US), LLC, New York, NY (US)

(72) Inventors: John T. LiVoti, Clearwater, FL (US); Stanley Wellington Woodruff, Palm Harbor, FL (US)

(21) Appl. No.: 19/206,391

(22) Filed: May 13, 2025

(51) Int. Cl. H04N 21/647; H04N 21/2343

(52) U.S. Cl. CPC H04N 21/64761; H04N 21/2343; H04N 21/64784

(57) ABSTRACT

In one example, a method for updating network traffic data acquisition parameters of a streaming meter device based on a data acquisition policy is described. The method includes: obtaining network traffic data including: multiple device identifiers, network parameters for a target device identifier characterizing a network activity associated with a target device, and a parental control restriction data element generated by an application associated with a media presentation device through which a consumer is exposed to media, processing the target device identifier, the network parameters, and the parental control restriction data element, to generate the data acquisition policy, and updating a current set of network traffic data acquisition parameters of the streaming meter device using the data acquisition policy such that the streaming meter device does not transmit the network traffic data associated with the target device identifier to a server of the audience measurement entity.

### FIELD OF THE DISCLOSURE

This disclosure relates generally to media monitoring and, more particularly, to methods, systems, and articles of manufacture for controlling (e.g., allowing and/or restricting) network traffic data collection by a measurement device for a client device associated with a location where consumers are exposed to media.

### USAGE AND TERMINOLOGY

In this disclosure, unless otherwise specified and/or unless the particular context clearly dictates otherwise, the terms “a” or “an” mean at least one, and the term “the” means the at least one.

Unless specifically stated otherwise, descriptors such as “first,” “second,” “third,” etc., are used herein without imputing or otherwise indicating any meaning of priority, physical order, arrangement in a list, and ordering in any way, but are merely used as labels or arbitrary names to distinguish elements for ease of understanding the disclosed examples. In some examples, the descriptor “first” can be used to refer to an element in the detailed description, while the same element can be referred to in a claim with a different descriptor such as “second” or “third.” In such instances, it should be understood that such descriptors are used merely for identifying those elements distinctly that might, for example, otherwise share the same name.

As used herein, the terms “approximately,” “substantially,” and “about” modify their subjects/values to recognize the potential presence of variations that occur in real world applications. For example, “approximately,” “substantially,” and “about” can modify dimensions that may not be exact due to manufacturing tolerances or other real-world imperfections, as will be understood by persons of ordinary skill in the art. For example, “approximately,” “substantially,” and “about” can indicate that such dimensions are within a tolerance range of +/−10%, unless otherwise specified in the below description.

As used herein, the phrase “communicatively coupled,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the term “computer program,” can generally refer to a program suitable for use in any type of computing environment that can be written in any form of programming language, e.g., compiled or interpreted languages, or declarative or procedural languages. A computer program can be deployed to be executed on one computer or on multiple computers that are located at one site or distributed across multiple sites and interconnected by any appropriate type of data communication network. Generally, a program can be deployed in any form, e.g., as a stand-alone program or as a module, component, subroutine, or other unit suitable for use in a computing environment. In some cases, the term “computer program” can also be described as a software, a software application, an app, a module, a software module, a script, or a code. In some cases, a computer program can correspond to a file in a file system. For example, a computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

As used herein, the term “engine” can be used broadly to refer to a software-based system, subsystem, or process that is programmed to perform one or more specific functions. Generally, an engine will be implemented as one or more software modules or components, installed on one or more computers in one or more locations, In some cases, one or more computers will be dedicated to a particular engine; in other cases, multiple engines can be installed and running on the same computer or computers.

### SUMMARY

This specification generally describes systems and methods that can update network traffic data acquisition parameters of a streaming meter device based on a data acquisition policy generated using a parental control restriction data element. The parental control restriction data element can be received from an application that is configured to limit streaming of media content based on parental control restrictions effected through, e.g., a platform of a streaming service provider, on a media presentation or client device, or in any other appropriate manner. The streaming meter device can be disposed at a media exposure measurement location (e.g., a consumer household) where consumers, such as panelists of an audience measurement entity (AME), are exposed to media through the media presentation (or client) device associated with the application. In one example, consumers can be exposed to media by streaming media content via a network (e.g., the Internet) associated with the network system to any appropriate media presentation (or client) device having streaming capabilities, e.g., desktop and laptop computers, tablets, mobile phones, or any other appropriate media presentation device. This network or streaming activity can be collected by a streaming meter device that monitors network traffic data passing through the network system at the media exposure measurement location.

The parental control restriction data element can define, e.g., a configuration of the application that restricts certain devices from accessing media content having pre-defined media ratings, which are described in more detail below. The systems and methods described in this specification can generate the data acquisition policy for the streaming meter device based on the parental control restriction data element received from the application and use the parental control restriction data element to automatically update network traffic data acquisition parameters of the streaming meter device, such that the network traffic data acquisition parameters reflect the restrictions defined in the data acquisition policy. For example, the systems and methods described in this specification can allow or restrict collection of network traffic data, by the streaming meter device, for a particular device at the media exposure measurement location in accordance with the data acquisition policy.

In this manner, the systems and methods described in this specification can automatically establish privacy-preserving measures that prohibit network traffic data collection for some users, e.g., for children or minors under 18 years old, under 16 years old, under 10 years old, under 5 years old, or of any other appropriate age. These privacy-preserving measures are designed to protect children's privacy in accordance with various local, state, and national regulations. One example of such regulations is the Children's Online Privacy Protection Act (COPPA), which restricts data collection from children under the age of 13.

The systems and methods described in this specification can automatically update the network traffic data acquisition parameters of the streaming meter device based on the parental control restrictions received from the application, which can facilitate a much more efficient addition, or removal, of devices from being monitored than would have been possible otherwise. The systems and methods described in this specification can remove or reduce the need for manual configuration of devices, such as the streaming meter device associated with the AME, in accordance with data collection restrictions, thereby also removing the need for frequent visits of field representatives to the consumers' household and reducing overall costs of installation and maintenance of monitoring equipment.

Furthermore, any standard manual data gathering process is prone to error, e.g., human error such as mistakes in data entry. The systems and methods described in this specification can automatically update the network traffic data acquisition parameters thereby allowing immediate access to gathered data and reducing errors that might occur through manual reporting or data entry. By automatically updating the network traffic data acquisition parameters of the streaming meter device, the systems and methods described in this specification can collect network traffic data with greater accuracy and using fewer computational resources (e.g., memory and computing power) than other conventional systems. Moreover, AMEs can use the network traffic data to generate media exposure data for crediting purposes with greater accuracy, thereby allowing broadcasters and advertisers to make effective advertising/media inventory optimization decisions.

In a first aspect, there is provided a method for updating network traffic data acquisition parameters of a streaming meter device associated with an audience measurement entity, the streaming meter device disposed at a media exposure measurement location where a consumer is exposed to media through a media presentation device. The method includes: obtaining, by the streaming meter device via a network, network traffic data including: multiple device identifiers identifying respective devices associated with the media exposure measurement location, each device of the respective devices configured to stream media via the network, one or more network parameters for a target device identifier of multiple device identifiers, where the one or more network parameters characterize a network activity associated with a target device identified by the target device identifier, and at least one parental control restriction data element for the target device identifier, where the at least one parental control restriction data element is generated by an application associated with the media presentation device through which the consumer is exposed to media.

The method further includes: processing the target device identifier, the one or more network parameters, and the at least one parental control restriction data element to generate a data acquisition policy that specifies a network traffic data acquisition restriction for the target device identifier, and updating a current set of network traffic data acquisition parameters of the streaming meter device using the data acquisition policy and the target device identifier such that the streaming meter device does not transmit the network traffic data associated with the target device identifier to a server of the audience measurement entity.

In a second aspect, there is provided a system that includes: at least one processor, and a memory storing program instructions that, when executed by the at least one processor, cause performance of operations of any preceding aspect.

In a third aspect, there is provided a non-transitory computer-readable storage medium storing program instructions that, when executed by at least one processor, cause performance of any preceding aspect.

### BRIEF DESCRIPTION OF THE DRAWINGS

FIG. 1A and FIG. 1B are illustrations of an example acquisition system in which various described operations can be implemented.

FIG. 2A is an illustration of an example user interface of an application configured to generate a parental control restriction data element.

FIG. 2B is an illustration of an example user interface of a streaming meter device configured according to a data acquisition policy.

FIG. 2C is an illustration of example streaming meter events generated based on network traffic data.

FIG. 3 is a flow chart of an example method for updating network traffic data acquisition parameters of a streaming meter device.

FIG. 4 is a simplified block diagram of an example computing device.

### DETAILED DESCRIPTION

### I. Overview

Audience measurement entities (AMEs) are entities that collect data about media consumption by consumers, referred to herein as “media exposure data,” for various purposes. Generally, media exposure data can characterize who is consuming media, what type of media is being consumed, and/or how the media is being consumed. In one example, media exposure data can include data that identifies media (e.g., metadata, codes, signatures, watermarks, etc.), data that identifies consumers (demographic information, usernames, etc.) and, in some cases, data that identifies how the media was presented to the consumer (e.g., an identifier of an application, time/duration of use of the application, type of media presentation device, platform, etc.). Media exposure data collected by the AMEs can be used by other entities such as advertisers to improve the effectiveness of their advertising campaigns, and broadcasters to gain a deeper insight into channel viewership.

Throughout this specification, the term “media content” can refer to media data or information of any appropriate type (e.g., television programs, advertisements, videos, movies, images, websites, games, etc.) delivered to a consumer via any appropriate distribution channel, e.g., television, radio, publishing/streaming via the Internet, or any other appropriate distribution channel. The term “digital media” can refer to a subset of media that includes those content items that are accessible via the Internet. As a particular example, digital media can be streamed via the Internet to media presentation devices, also referred to herein as client devices, such as desktop and laptop computers, tablet computers, mobile phones, or any other appropriate type of client device.

AMEs can collect media exposure data for digital media by using a streaming meter device. Throughout this specification, a “streaming meter device” refers to a device that can be coupled to a network provided by a network system (e.g., a local area network (LAN) and/or a wide area network (WAN)) at a consumer household and can monitor network traffic to collect network traffic data. Throughout this specification, a “network system” can refer to one or more network devices that work together to establish a network connection and network distribution at the consumer household, such as a modem, a router, and any other appropriate network device. The devices included in the network system can be communicatively coupled with each other in any appropriate manner, e.g., through a wired, or wireless, connection.

The streaming meter device can be in the form of a separate unit (e.g., separate from a modem and/or a router at the consumer household), can be installed at any appropriate location in the consumer household, and can be coupled to any other client or network device at the household through a wired, or wireless, connection. As a particular example, the streaming meter device can be communicatively coupled to a router of the network system (and/or any other devices at the consumer household) via a wired (e.g. Ethernet) connection. In some cases, the streaming meter device can additionally, or alternatively, be communicatively coupled to the network and any other client or network devices at the consumer household via a wireless connection. Additionally or alternatively, the streaming meter device can also function as a network system at the consumer household, e.g., as a modem and/or router at the consumer household.

In some cases, the network system can be configured to provide different types of networks at the consumer household, e.g., LAN, WAN, and any other appropriate type of network. For example, WAN can be implemented by data busses, cellular networks, private networks, public networks, or in any other appropriate manner. The streaming meter device can be communicatively coupled to a server of the AME through the WAN. Similarly, the streaming meter device can be communicatively coupled to one or more network and client devices at the consumer household through the LAN provided by the network system.

In some cases, the streaming meter device can be configured to query, via the network, client and network devices at the consumer household, e.g., modem, router, desktop and laptop computers, tablet computers, mobile phones, and any other type of device. The streaming meter can obtain, from the client and network devices and via the network, data characterizing status and configuration of, and processes running on, the devices at the consumer household. The streaming meter device can store this data in an internal memory of the streaming meter device and/or transmit this data to a server of the AME. As a particular example, the streaming meter device can query a router of the network system, to which it is connected via a wired connection, and then transmit the received data from the router via a wireless connection to a remote server.

AMEs enroll consumers who consent to being monitored into a registered consumer panel. Then, AMEs can install and maintain various media monitoring and media tracking equipment, including streaming meter devices, in registered panelist's households. As part of the enrollment process, AMEs can collect various types of information directly from the consumers about their household, e.g., types of client devices used by the consumers to access media at the household, device identifiers for the devices, demographic information about the consumers (e.g., age, gender, etc.), whether any children or minors are present at the household, and any other appropriate information. The AMEs can store this information in an audience measurement database, and this information obtained directly from the consumers can form a part of the media exposure data collected by the AMEs. The audience measurement database need not necessarily include typical device identifiers, such as IP addresses and MAC addresses, but can instead specify any other appropriate device identifiers represented in any appropriate manner, e.g., as an alphanumeric sequence.

In some cases, AMEs can associate data collected directly from consumers, e.g., during consumer enrollment into the panel, with data elements from the network traffic data collected by the streaming meter by monitoring network traffic at the consumer household. As a particular example, AMEs can associate a MAC address of a device at the consumer household specified by the network traffic data with demographic information about the consumer who owns and/or uses the device, as indicated by the information provided directly by the consumer during enrollment into the panel. In this manner, the AMEs can generate media exposure data that provides a mapping between the media being consumed through the device at the consumer household and the demographic information of the consumer who is exposed to media through the device.

As described above, the streaming meter device collects network traffic data associated with client and network devices at the consumer household. Throughout this specification, the term “network traffic data” refers to data associated with the network at the consumer household and can include device identifiers and various types of data elements and network activity parameters associated with network activity of devices. For example, the network traffic data can include domain names, host names, port numbers, uniform resource locators (URLs), device fingerprinting data, total bandwidth usage per session, real-time bandwidth throughput, bitrate estimation, time stamps such as streaming session start and stop times, traffic volume, data specific to the streaming service provider such as download patterns and buffer caching, content metadata, device identifiers, and any other appropriate type of data. The device identifiers can include, e.g., IP addresses, MAC addresses, and any other appropriate type of device identifiers.

As a particular example, the network traffic data can include one or more network parameters for a device identifier that characterize a network activity of the device associated with the device identifier. Generally, at least some of the network parameters included in the network traffic data can represent a streaming activity of the device due to, e.g., streaming of media content via the network to a client/media presentation device. Similarly, at least some of the network parameters included in the network traffic data can represent a non-streaming activity of the device due to, e.g., instant messaging, web browsing, application syncing, software updates, or any other appropriate type of non-streaming activity. In some cases, the non-streaming activity can also include an absence of any type of network activity by the device, e.g., if it is not being used by a consumer but is still connected to the network, or is in any other appropriate state.

In one example, the network parameters can include a data packet size network parameter that can represent an amount of data (e.g., in bytes) included in a single data packet. For streaming network activity of devices, the data packet size network parameters can be substantially large (~1,400 bytes per packet) and consistent in the network traffic data, whereas for non-streaming activity the data packet size network parameters can be substantially small (~100 bytes). In another example, the network parameters can include a traffic direction that represents a flow of data between devices on the network, specifically whether the data is being sent or received by a particular device. For streaming network activity of devices, the traffic direction can be substantially downstream, e.g., download-heavy, whereas for non-streaming activity the traffic direction can be more substantially balanced or bi-directional.

In another example, the network parameters can include a flow duration that represents a length of time that a network communication session between two endpoints remains active, which can be represented by reception of a first data packet indicating a beginning of the communication session and reception of a second data packet indicating an end or a timeout of the session. For streaming network activity of devices, the flow duration can represent long-lived communication sessions, e.g., five minutes, thirty minutes, 1 hour, 2 hours, or any other appropriate length of time. For non-streaming network activity of devices, the flow duration can represent short-lived communication sessions, e.g., one second, two seconds, five seconds, 1 minute, or any other appropriate length of time.

In another example, the network parameters can include a bandwidth usage that represents an amount of data (e.g., a number/size of data packets, measured in bits, kilobits, megabits, or gigabits, per second) transmitted via the network over a period of time (e.g., a second). For streaming network activity of devices, the bandwidth usage can include a substantially high (~25 megabits per second) and steady bandwidth. For non-streaming network activity of devices, the bandwidth usage can include a substantially low (~0.05 megabits per second) and bursty or irregular bandwidth. Generally, the streaming activity and the non-streaming activity of devices on the network can be represented by any other appropriate parameters in the network traffic data collected by the streaming meter device.

The network traffic data collected by the streaming meter device can further include a parental control restriction data element that can characterize a parental control restriction on media streaming effected by an application associated with a device to which the media is being streamed or attempted to be streamed. In some cases, the parental control restriction data element can include any of the network parameters described above. In some cases, the parental control restriction data element can include a hypertext transfer protocol/hypertext transfer protocol secure (HTTP/HTTPS) response code, such as the “403” code, the “401” code, or the “302” code. The “403” code can indicate that access to media content is denied due to parental control or content restrictions. The “401” code can indicate that the user is not permitted to access the content, which could be due to age, account type or login. The “302” code can indicate that the webpage including the media content is being redirected to another page, e.g., the application parental settings page, help page, or any other appropriate page.

In some cases, the parental control restriction data element can characterize a short-lived connection to the media content URL, indicating that access to the media content has been attempted (e.g., in response to a request sent to a streaming service provider from the client/media presentation device), but is then followed by a rejection or redirect to another URL. As another example, the parental control restriction data element can characterize a resolved domain name system (DNS) resulting in a successful translation of a domain name (e.g., video.netflix.com) into an IP address (e.g., 198.38.51.24), but an absence of a beginning of streaming activity (e.g., no reception of a data packet that would characterize streaming activity). Generally, the parental control restriction data element can include any other appropriate network parameter, or multiple network parameters.

In some implementations, the parental control restriction data element is generated by a software application installed on a client device (e.g., a mobile phone, a tablet computer, a laptop, or any other appropriate type of client device). The software application can be configured to filter, monitor, and enforce parental control restrictions on the client device, e.g., across all other applications and services associated with the client device. In such cases, the parental control restriction data element can include, e.g., a data element characterizing a network communication of the application with a parental control service. As another example, the parental control restriction data element can include a “fake” or “null” IP address which can be received in response to a request for media content which is blocked by the application. As another example, the parental control restriction data element can include a URL of a redirect webpage that specifies a parental control restriction. As another example, the parental control restriction data element can include a custom HTTP header which tracks or enforces parental control restriction rules, e.g., X_Parental_Control: enabled.” Generally, the parental control restriction data element generated by an application installed on a client device can include any other appropriate data.

The streaming meter device can collect network traffic data in accordance with network traffic data acquisition parameters. Throughout this specification, “network traffic data acquisition parameters” refer to a set of restriction rules used by the streaming meter device to determine client and network devices for which it is permitted, or not permitted, to collect network traffic data in particular circumstances. The network traffic data acquisition parameters can ensure that the network traffic data is only collected from eligible, consented, enrolled, and relevant devices, over an appropriate and predefined period of time, for audience measurement purposes. For example, the network traffic data acquisition parameters can indicate whether a particular device is media streaming capable or not. In such cases, the streaming meter device can be blocked from collecting network traffic data for which the network traffic data acquisition parameter indicates that the device is, e.g., not media streaming capable.

As another example, the network traffic data acquisition parameters can indicate whether a particular device is associated with any other network in the consumer household in addition to the primary network. In such cases, the streaming meter device can be blocked from collecting network traffic data for which the network traffic data acquisition parameter indicates that the device is, e.g., associated with other networks in addition to the primary network.

As another example, the network traffic data acquisition parameters can indicate whether a particular device is subject to a parental control restriction. Throughout this specification, a “parental control restriction,” a “parental control restriction parameter,” and a “parental control restriction data element” refers to a restriction rule that controls the flow of network traffic data (e.g., due to streaming of media content) to a client device, and/or the collection of network traffic data associated with the client device by the streaming meter device. As described above, in some cases, the parental control restriction data element can include one or more network parameters associated with network activity of a device. In some cases, the parental control restriction data element can specify a media rating of the media being streamed, or attempted to be streamed to the client device.

Throughout this specification, a “media rating” refers to a standardized classification assigned to media content that indicates its appropriateness for different age groups, based on aspects such as sexual content, violence, language, or any other appropriate type of media content themes. In another example, the parental control restriction data element can specify a URL, a domain, a subdomain, or a deny list of websites that are to be blocked from access. In another example, the parental control restriction data element can specify keywords in URLs for websites to be blocked, e.g., “adult” or “gambling.” In another example, the parental control restriction data element can specify filters based on content categories, e.g., “violence” “weapons” “social media” or any other appropriate category. In some cases, the parental control restriction data element can specify a blocked application, e.g., a social media application, such as “TikTok,” “Snapchat,” or any other appropriate application.

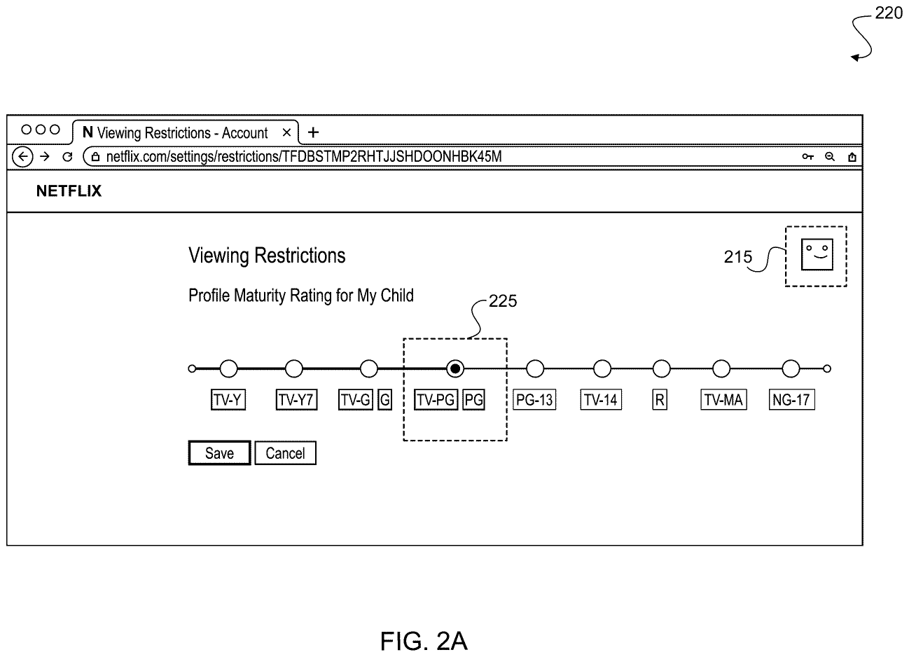

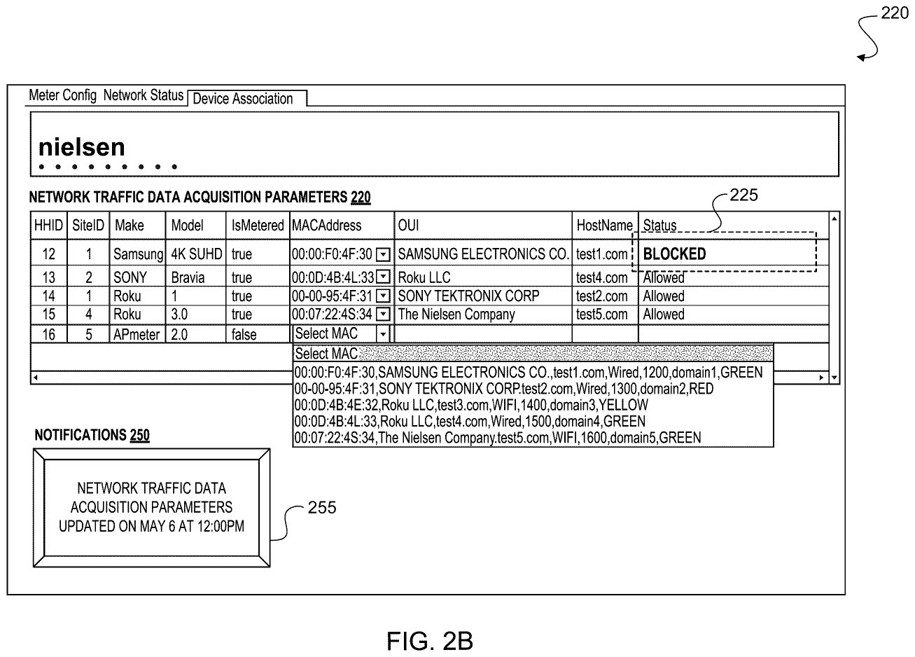

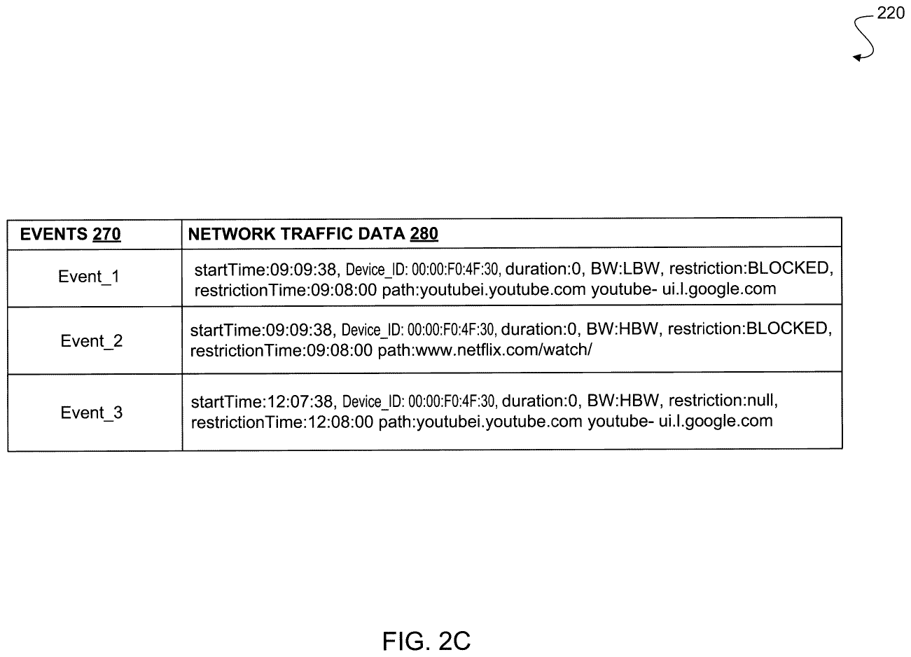

If a network traffic acquisition parameter for a particular client device specifies the parental control restriction, the streaming meter device can interpret the network traffic acquisition parameter to mean that the client device is being used, or is intended to be used, by a minor or a child at the consumer household. This can trigger the implementation of privacy-preserving measures imposed by the AME associated with the streaming meter device, in order to comply with child privacy protection regulations. As a particular example, when the streaming meter device is configured according to a network traffic data acquisition parameter that specifies a parental control restriction for a particular client device, the streaming meter device can refrain from collecting network traffic data associated with this client device. Additionally, or alternatively, the streaming meter device can refrain from transmitting the network traffic data associated with the client device to a server of the AME, or any other appropriate destination. Example network traffic acquisition parameters are described in more detail below with reference to FIG. 2B.

As described above, the systems and methods described in this specification can automatically update network traffic data acquisition parameters of the streaming meter device, thereby automatically enforcing privacy-preserving measures related to media content access by children and minors. In some cases, the systems and methods described in this specification can perform this update based on a data acquisition policy generated based on a parental control restriction data element generated by an application associated with, e.g., a client device, a streaming platform, or any other appropriate application configured to set parental control restrictions, An example application is described in more detail below with reference to FIG. 2A.

Throughout this specification, a “data acquisition policy refers to a set of restrictions associated with the streaming meter device that determine which devices are eligible, consented, enrolled, and relevant for data collection for media exposure measurement purposes. In some implementations, the network traffic data does not include the parental control restriction data element. In such cases, the systems and methods described in this specification can generate the data acquisition policy based on a device identifier representing a client/media presentation device and one or more network parameters associated with the device included in the network traffic data collected by the streaming meter. Then, the systems and methods described in this specification can update the network traffic data acquisition parameters of the streaming meter device based on the data acquisition policy.

By automatically updating the network traffic data acquisition parameters of the streaming meter device based on the data acquisition policy, the systems and methods described in this specification can collect network traffic data using the streaming meter device only for those devices which are eligible, consented, enrolled, and relevant. In other words, the network traffic data for client devices which do not comply can be blocked from collection or discarded, thereby focusing only on the network traffic data which is compliant and relevant for audience measurement purposes. Therefore, the systems and methods described in this specification facilitate network traffic data collection with greater accuracy and using fewer computational resources (e.g., memory and computing power) than other conventional systems. Further, AMEs can use the network traffic to generate media exposure data with greater accuracy, thereby allowing broadcasters and advertisers to make effective advertising/media inventory optimization decisions. Moreover, the systems and methods described in this specification ensure that an AME does not acquire data that could endanger child privacy and undermine corresponding privacy-preserving regulations, ensuring data integrity and compliance.

### II. Acquisition System Architecture

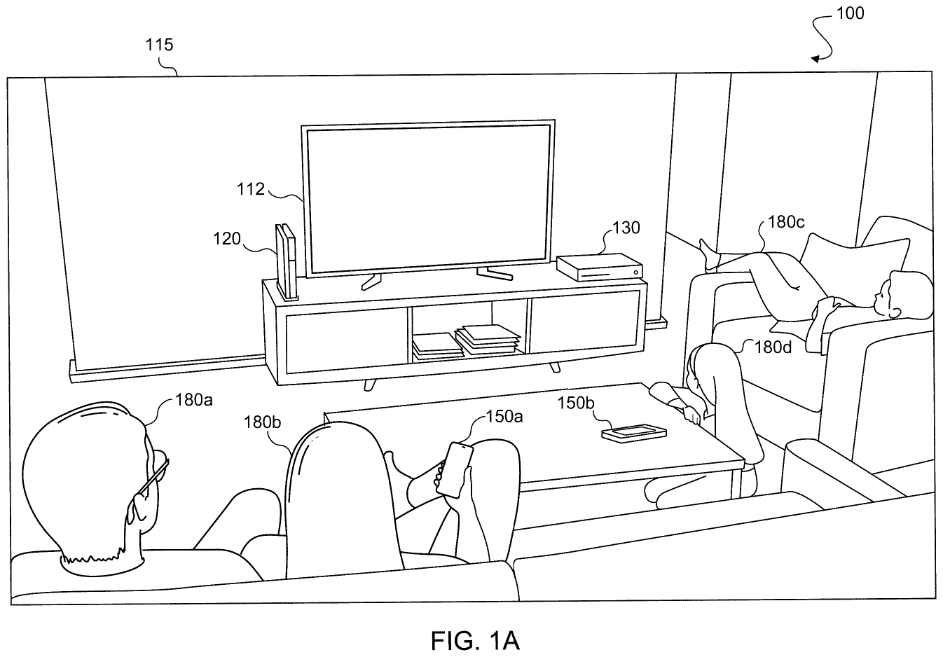

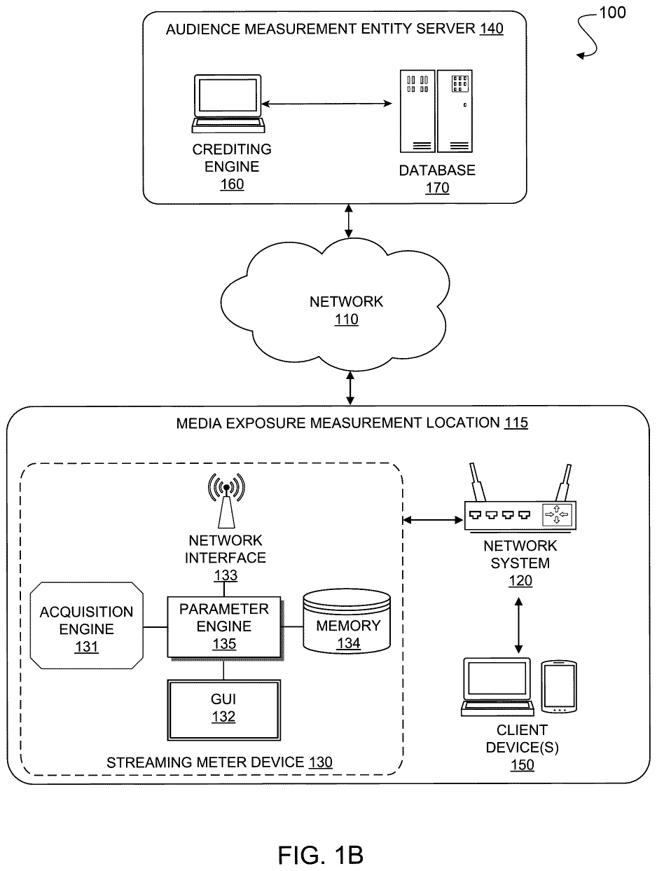

FIG. 1A and FIG. 1B illustrate an example acquisition system 100 in which various described operations can be implemented. As illustrated in FIG. 1A, the acquisition system 100 includes a media exposure measurement location 115, e.g., a consumer household of consumers 180a, 180b, 180c, 180d who are registered panelists with an AME, or any other appropriate location where consumers 180a, 180b, 180c, 180d are exposed to media. As shown in FIG. 1A, the consumers 180c, 180d are child consumers. The media exposure measurement location 115 can be any appropriate area within the consumer household, e.g., a living room, a bedroom, a kitchen, etc. In some cases, the media exposure measurement location 115 can be associated with a media presentation device 112 (also referred to herein as a client device), such as a television, or any other appropriate type of device that can provide media exposure to consumers 180.

The acquisition system 100 further includes a streaming meter device 130, a network system 120, and, e.g., one or more client devices 150a and 150b other than the media presentation device 112. The streaming meter device 130, the media presentation device 112, and the client devices 150 can be coupled to a network 110 (illustrated in FIG. 1B) provided by the network system 120 (e.g., a modem and/or a router, or any other appropriate number and type of network devices) at the media exposure measurement location 115. The network can be, e.g., a local area network (LAN), a wide area network (WAN) (e.g., the Internet), or any other appropriate type of network.

The streaming meter device 130 is configured to monitor network traffic to collect network traffic data associated with the network at the media exposure measurement location 115. This network traffic data can include information about network activity of the client devices 150 and the media presentation device 112. In one example, the streaming meter device 130 can be communicatively coupled to the network system 120, via a wired or wireless connection, and can monitor network traffic passing through the network system 120. In some instances, the streaming meter device 130 and/or one or more of the client devices 150a, and 150b are located in another room, e.g., a different room of the consumer household from the one where the network system 120 is located. Generally, the streaming meter device 130 can be coupled to the network and configured to monitor network traffic to collect network traffic data in any appropriate manner.

The acquisition system 100 can include any appropriate number of client devices 150 and media presentation devices 112, e.g., one device, two devices, five devices, ten devices, or any other appropriate number of devices. Further, the client devices 150 can be of any appropriate type. For example, as illustrated in FIG. 1A, a first client device 150a can be a mobile phone, and a second client device 150b can be a tablet computer.

Turning to FIG. 1B, the streaming meter device 130 disposed at the media exposure measurement location 115 can be communicatively coupled to a server 140 of the AME via the network 110. The server 140 can include an audience measurement database 170 and a crediting engine 160. The streaming meter device 130 can include a network interface 133, a parameter engine 135, an acquisition engine 131, a memory 134, and a graphical user interface (GUI) 132. In some cases, any of the components of the streaming meter device 130 are implemented by the server 140 of the AME. As a particular example, the parameter engine 135 and/or the acquisition engine 131 can be implemented by the server 140 and be communicatively coupled to the streaming meter device 130. In some cases, any of the components of the server 140 are implemented by the streaming meter device 130. As a particular example, the audience measurement database 170 can be implemented in the memory 134 of the streaming meter device 130. The components of the streaming meter device 130 and the server 140 are provided for illustrative purposes only, and generally the streaming meter device 130 and the server 140 can additionally or alternatively include any other components arranged in any appropriate manner in any number of locations and configured to perform any appropriate function.

The network interface 133 of the streaming meter device 130 can include wired (e.g., an Ethernet cable) and/or wireless (e.g., a cellular, Wi-Fi, or Bluetooth®) interfaces. The streaming meter 130 can use the network interface 133 to communicate with any other devices of the acquisition system 100 and the server 140 of the AME. Generally, the streaming meter device 130 can communicate with any device of the acquisition system 100 and the server 140 of the AME in any appropriate manner, such as through Internet messages (e.g., HTTP request(s)) that can include, e.g., data obtained by the streaming meter device 130. Other example modes of communication between the streaming meter device 130 and other components of the acquisition system 100 can include an HTTP Secure protocol (HTTPS), a file transfer protocol (FTP), a secure file transfer protocol (SFTP), or any other appropriate mode of communication.

As described above, the server 140 of the AME can include the audience measurement database 170 configured to store, e.g., audience measurement data and/or media exposure data, Generally, the audience measurement database 170 can be located in any appropriate location, or multiple locations. In some cases, the audience measurement database 170 can be remote from the server 140. The audience measurement database 170 can store information associated with media consumption by consumers at the media exposure measurement location 115. For example, the audience measurement database 170 can store information provided directly by consumers during enrollment into the panel by the AME, such as device identifiers for client devices and presence of any children or minors at the household, as described above. As another example, the audience measurement database 170 can store network traffic acquisition parameters of the streaming meter device 130, which can be defined based on the data acquisition policy, As a particular example, the audience measurement database 170 can specify, for each device identifier associated with a client device at the consumer household a corresponding set of network traffic data acquisition parameters which can include, e.g., parental control restrictions and periods of time for which the restrictions are active.

The audience measurement database 170 can additionally or alternatively store any other appropriate information. The audience measurement database 170 can be implemented by any type of memory, storage device, and/or storage disc for storing data such as, for example, flash memory, magnetic media, optical media, solid state memory, hard drive(s), thumb drive(s), etc. Furthermore, the data stored in the audience measurement database 170 may be in any data format such as, for example, binary data, comma delimited data, tab delimited data, structured query language (SQL) structures, or any other appropriate type of data.

The server 140 of the AME can further include the crediting engine 160. The crediting engine 160 is configured to use data received from the streaming meter device 130, and/or one or more other types of devices and sources, to generate media exposure data for the AME. Example operations performed by the crediting engine 160 are described in more detail below.

The crediting engine 160 can be configured to perform input collection. For example, the crediting engine 160 can receive watermarks, content signatures, or other media identification data from linear TV broadcasts, collect viewing data from consumer household panels and set-top boxes, collect census-based data and demographic information for digital content, process signals from portable people meter devices, ingest tagged data from podcast publishers, or perform input collection in any other appropriate manner. The crediting engine 160 can be further configured to process the data collected. For example, the crediting engine 160 can decode watermarks and match content signatures, aggregate and normalize data from various sources, apply demographic modeling to raw viewing/listening data, deduplicate cross-platform audience data, or process the collected data in any other appropriate manner.

The crediting engine 160 can be further configured to perform time-shift analysis. For example, the crediting engine 160 can identify and categorize time-shifted viewing (e.g., digital video recorder (DVR), on-demand), calculate metrics for different reporting windows (Live+Same Day, Live+3, Live+7), or perform time-shift analysis in any other appropriate manner, The crediting engine 160 can be further configured to perform average commercial minute calculation. For example, the crediting engine 160 can isolate commercial breaks within programs, compute average viewership for all commercial minutes, or perform average commercial minute calculation in any other appropriate manner.

The crediting engine 160 can be further configured to perform cross-platform integration. For example, the crediting engine 160 can align metrics across TV, digital, and audio platforms, apply modeling techniques for comparable cross-media measurement, or perform cross-platform integration in any other appropriate manner. The crediting engine 160 can be further configured to perform out-of-home incorporation. For example, the crediting engine 160 can process out-of-home viewing data from personal people meter devices, integrate out-of-home data with in-home viewing metrics, or perform out-of-home incorporation in any other appropriate manner.

The crediting engine 160 can be further configured to perform credit assignment. For example, the crediting engine 160 can attribute viewership/listenership to specific programs, commercials, or media content pieces, assign demographic breakdowns to credited audiences, or perform credit assignment in any other appropriate manner. The crediting engine 160 can be further configured to perform reporting. For example, the crediting engine 160 can generate media exposure data, standardized ratings and reach metrics, generate reports including these ratings and metrics and/or media exposure data, or perform reporting in any other appropriate manner.

The memory 134 of the streaming meter device 130 can be implemented by, e.g., a local memory, a volatile/non-volatile memory, a mass storage, or any other appropriate storage medium. The memory 134 can store, e.g., the network traffic data collected by the streaming meter device 130, data received from other devices of the acquisition system 100, data received from the server 140 of the AME, data acquisition policies, network traffic data acquisition parameters of the streaming meter device 130, and any other appropriate data.

The GUI 132 can include visual elements to facilitate user interaction with the streaming meter device 130. The GUI 132 can include three components, a login section for logging into the system, an initial application installation section for installing the software associated with the streaming meter device (which can include, e.g., the parameter engine 135 and the acquisition engine 131, as described below), and an application user interface for receiving user input and displaying information. As a particular example, the login and initial application installation can be built into a firmware of the streaming meter device 130, while the application user interface can be included in, and updated with, a software application package of the streaming meter device 130.

The software application package of the streaming meter device 130 can be configured to generate notifications in the GUI 132 indicating different types of information and alerts, e.g., that the network traffic data acquisition parameters have been updated. In some cases, the software application package of the streaming meter device 130 can receive user input from a user, through the GUI 132, indicating whether a current set of network traffic data acquisition parameters of the streaming meter device 130 should be updated or not. An example GUI 132 of the streaming meter device 130 is described in more detail below with reference to FIG. 2B, In some examples, the GUI 132 is provided via a display of the streaming meter device 130. In other examples, the GUI 132 is accessible via a separate computing device wired or wirelessly coupled to the streaming meter device 130, such as one or more of the client devices 150. For instance, a client device 150 can access the GUI 132 via an application or a browser of the client device 150.

As described above, the streaming meter device 130 can further include an acquisition engine 131 and a parameter engine 135. The acquisition engine 131 can be configured to communicate, via the network interface 133 (which can include a wired or wireless connection to the network system 120), with the network system 120 (e.g., a modem and/or a router) to obtain network traffic data that can characterize network activity of the media presentation device 112 and the client devices 150a, 150b. For example, the network traffic data can include one or more device identifiers identifying respective devices (e.g., client devices 150a, 150b) associated with the media exposure measurement location 115, one or more network parameters for a target device identifier of the one or more device identifiers, and at least one parental control restriction data element. The acquisition engine 131 can be configured to store the network traffic data, and any other information such as a time stamp indicating a time when the network traffic data was received, in the memory 134 of the streaming meter device 130.

The parameter engine 135 can be configured to process the target device identifier, the one or more network parameters, and the parental control restriction data element to generate a data acquisition policy that specifies a network traffic data acquisition restriction for the target device identifier The parental control restriction data element being set as restricted, or including any other type of data indicating a restriction, as described above, can suggest that the device represented by the target device identifier may be used by a child or a minor. The parameter engine 135 can use the target device identifier and the data acquisition policy to update the network traffic data acquisition parameters of the streaming meter device 130 such that the streaming meter device 130 does not monitor network traffic data associated with a device represented by the target device identifier. In other words, the parameter engine 135 can prevent collection and/or distribution of data that may reflect network activity of the device stemming from its use by a child or a minor. In this manner, the parameter engine 135 can automatically update network traffic data acquisition parameters of the streaming meter device 130, thereby automatically enforcing privacy-preserving measures related to media content access by children and minors. Example operations of the acquisition system 100 are described in more detail next.

### III. Example Operations of the Acquisition System

As described above, the acquisition engine 131 can receive network traffic data, including device identifiers, one or more network parameters for a target device identifier, and at least one parental control restriction data element for the target device identifier. The device identifiers can be for devices associated with the media exposure measurement location 115, e.g., a MAC address of the first client device 150a, and a MAC address of the second client device 150b.

The acquisition engine 131 can provide this data to the parameter engine 135. The parameter engine 135 can process this data to generate the data acquisition policy that specifies a network traffic data acquisition restriction for the target device identifier. For example, the acquisition engine 131 can determine that the one or more network parameters include a low bandwidth network traffic parameter associated with non-streaming network activity of the target device, as described above. The low bandwidth network traffic parameter can be associated with a time stamp that indicates either a particular time, or a time period, when the target device represented by the target device identifier is engaged in low bandwidth network activity, such as messaging. Similarly, the parental control restriction data element can be associated with a time stamp in the network traffic data which can represent a time when the parental control restriction data element is received, or detected, by the streaming meter device 130.

The parameter engine 135 can determine that a threshold amount of time after the reception of the parental control restriction data element (which can be any appropriate data element described above), the low bandwidth network traffic parameter was also received, characterizing non-streaming activity, or a lack of streaming of media content by the target device. Accordingly, the parameter engine 135 can determine that it is likely that the media content was requested by the target device but not returned due to a parental control restriction effected by the application, thereby indicating a potential use of the target device by a child or a minor. The threshold amount of time can be any appropriate amount of time, e.g., 1 millisecond, 5 milliseconds, 50 milliseconds, 1 second, 5 seconds, 30 seconds, 1 minute, 5 minutes, or any other appropriate amount of time. Accordingly, the parameter engine 135 can generate the data acquisition policy for the streaming meter device 130, which can specify, e.g., the one or more network parameters of the target device, the restriction indicated by the parental control restriction data element, and any other information characterizing the parental control restriction. The parameter engine 135 can use the data acquisition policy and the target device identifier to update the network traffic data acquisition parameters of the streaming meter device 130. This example is provided for illustrative purposes only, and generally the parameter engine 135 can generate the data acquisition policy in any other appropriate manner.

The parameter engine 135 can perform the data acquisition policy generation process described above for each device identifier specified by the network traffic data, for only one or more device identifiers specified by the network traffic data, or in any other appropriate manner. In some cases, the parameter engine 135 can perform the data acquisition policy generation process described above in response to a user input provided by a user through the GUI 132 of the streaming meter device 130. For example, the user input can indicate which device, device identifier, and/or user of the device (e.g., defined by a user profile on the streaming meter device 130 or the network system 120) the parameter engine 135 should perform the data acquisition policy generation process for, with respect to the parental control restriction data element received from the network system 120.

After generating the data acquisition policy, the parameter engine 135 can update the current set of network traffic data acquisition parameters of the streaming meter device 130 using the target device identifier such that the streaming meter device 130 does not monitor network traffic data associated with a device represented by the target device identifier. For example, the parameter engine 135 can replace a current network traffic acquisition parameter associated with parental controls for the target device identifier to reflect the parental control restriction data element specified by the data acquisition policy for the target device identifier.

This, in turn, reconfigures the way in which the streaming meter device 130 collects network traffic data. For example, the streaming meter device 130 can be blocked from collecting network traffic data for the target device identifier completely, e.g., such that the data packets associated with the target device identifier are not passed by the streaming meter device 130. As another example, the streaming meter device 130 can collect network traffic data for the target device identifier but delete this data from the memory 134 instantaneously, or after a predefined amount of time, e.g., after 1 minute, 5 minutes, 1 hour, 1 day, 1 week, or any other appropriate amount of time. As another example, the streaming meter device 130 can collect network traffic data for the target device identifier, store it in the memory 134, but not transmit this network traffic data to the server 140 of the AME. Generally, the streaming meter device 130 can be configured to not monitor network traffic data associated with a device represented by the target device identifier in any other appropriate manner. Accordingly, due to the application-level parental control restrictions specified by the data acquisition policy, the streaming meter device 130 can be automatically prevented from monitoring a device represented by the target device identifier that may be associated with a child or a minor.

After updating the current set of network traffic data acquisition parameters of the streaming meter device 130, the parameter engine 135 can transmit, via the network and to the server 140 of the AME, the updated set of network traffic data acquisition parameters. The AME can use this data for validation purposes, for compliance with regulations, or for any other purpose. In one example, the AME can use the updated network traffic data acquisition parameters specifying parental control restrictions for identifying households with children or minors and creating more accurate demographic profiles in a privacy-preserving manner. In other examples, the AME can analyze which types of content are most commonly restricted by parents, analyze how parental controls affect overall viewing patterns, and track the adoption rate of parental control features across different devices and platforms.

In some implementations, after updating the current set of network traffic data acquisition parameters, the acquisition engine 131 can receive a second different parental control restriction data element for the target device identifier. For example, if a user of the client device 150a, or media presentation device 112, requests the media content again, the network traffic data can include the second different parental control restriction data element associated with the second media content request. In some cases, the second parental control restriction data element can include different data from the data specified by the initial parental control restriction data element. In some cases, the second parental control restriction data element can be the same as the initial parental control restriction data element.

As a particular example, the initial parental control restriction data element can include an HTTP/HTTPS response code, such as the “403” code, and the second different parental control data element can include a custom HTTP header, e.g., “X_Parental_Control: enabled.” The parameter engine 135 can process the target device identifier, the second different parental control restriction data element, and the first data acquisition policy to generate a second data acquisition policy. The parameter engine 135 can update the current set of network traffic data acquisition parameters of the streaming meter device using the second data acquisition policy. In some cases, this can result in the streaming meter device 130 being blocked from collection of network traffic data associated with a device represented by the target device identifier.

However, in some cases the second different parental control restriction data element can specify data indicating that the target device is allowed to access the requested media content, in other words, the second different parental control data element can be “null” or can specify any other appropriate data indicating that the media is being streamed, or is allowed to be streamed, by the device. In such cases, after the current set of network traffic data acquisition parameters of the streaming meter device 130 has been updated using the second data acquisition policy, the streaming meter device 130 can obtain the network traffic data associated with the target device identifier, in accordance with the current set of network traffic data acquisition parameters, and transmit the network traffic data to the server 140 of the AME. Generally, the parameter engine 135 can generate the data acquisition policy for the target device identifier using any appropriate number of parental control restriction data elements specifying any appropriate type of data.

In some implementations, the parameter engine 135 can generate a modified device identifier based on the target device identifier of the target device, such that it can no longer be directly traced to a particular consumer or panelist. In other words, the modified device identifier can no longer point to a particular panelist, and associated personal information of the panelist, in the audience measurement database 170. For example, the parameter engine 135 can obfuscate or replace (e.g., randomly, or otherwise) one or more alphanumeric characters of the target device identifier. In another example, the parameter engine 135 can replace the target device identifier with one or more network parameters described above. In another example, the parameter engine 135 can use device attributes such as a make, model, operating system, or any other appropriate device attribute. Generally, the parameter engine 135 can generate the modified device identifier in any appropriate manner.

After generating the modified device identifier, the parameter engine 135 can update the current set of network traffic data acquisition parameters of the streaming meter device 130 using the data acquisition policy and the one or more modified device identifiers such that the streaming meter device 130 obtains network traffic data associated with the one or more modified device identifiers but does not obtain the network traffic data associated with the target device identifier. In other words, the streaming meter device 130 can be configured to collect network traffic data for a device identifier which may be difficult to trace to a particular consumer or panelist, ensuring that the network traffic data collection is performed in a privacy-preserving manner. In some cases, this can continue until a new parental control restriction data element is received indicating that the device is no longer subject to parental control restrictions, For example, the parameter engine 135 can generate the data acquisition policy that indicates that the network traffic data collection for the initial target device identifier can resume, and update the network traffic data acquisition parameters of the streaming meter device 130 accordingly such that it resumes collecting network traffic data for the target device identifier.

In some implementations, the acquisition system 100 is configured to generate a streaming meter device event indicating that the network traffic data associated with the target device identifier is being blocked due to parental control restrictions. Throughout this specification, a “streaming meter device event” refers to a discrete unit of recorded network activity collected by the streaming meter device 130. The streaming meter events can be used to log attempted access to media content, perform audience composition modelling and ensure accurate attribution, filter-out non-streaming network device activity from various datasets, improve cross-platform attribution, and in any other appropriate manner. The acquisition system 100 is configured to transmit, by the streaming meter device 130 the streaming meter device event to the server 140 of the AME. Example streaming meter device events are described in more detail below with reference to FIG. 2C. An example application that can generate a parental control restriction data element is described in more detail next.

FIG. 2A illustrates an example graphical user interface (GUI) 220 of an application configured to generate a parental control restriction data element. The application is associated with a streaming service provider of the media that the consumer is exposed to through the media presentation device or the client device. As illustrated in FIG. 2A, a user of the application (e.g. a parent) can interact with the GUI 220 to set parental control restrictions 225 for a user profile 215 of a child or a minor, such that they apply whenever the user profile 215 is logged in or active. When the child or minor accesses through the user profile 215 media content that is restricted by the parental control restrictions 225, the application can generate the parental control restriction data element that is returned in the network traffic data collected by the streaming meter device. An example user interface of a streaming meter device is described in more detail next.

FIG. 2B illustrates an example graphical user interface (GUI) 220 of a streaming meter device (e.g., the streaming meter device 130 in FIG. 1A and FIG. 1B) configured according to data acquisition policy including network traffic data acquisition parameters 230. The graphical user interface 220 can include a dashboard that provides users a consistent location for key information, such as the network traffic data acquisition parameters 230. As illustrated in FIG. 2B, the network traffic data acquisition parameters 230 can include, e.g., a site identifier “SiteID” for a site (e.g., living room, bedroom) within the consumer household, a device identifier “MACAddress,” and a network traffic acquisition parameter related to parental controls “Status.” For example, as illustrated in FIG. 2B, network traffic acquisition parameter for parental controls for the device identifier “00:00:F0:4F:30” is set as “Blocked,” indicating that the streaming meter device does not monitor network traffic data associated with a device represented by the device identifier “00:00:F0:4F:30.”

In some cases, the streaming meter device can generate a notification 255 in the graphical user interface 220 indicating that the current set of network traffic data acquisition parameters 230 has been updated, e.g., if the “Status” for “00:00:F0:4F:30” has been updated from “Allowed” to “Blocked,” indicating that the device represented by “00:00:F0:4F:30” may be used by a child and so the streaming meter device should not monitor network traffic data associated with this device.

In some cases, in response to generating the data acquisition policy for the target device identifier for which the parental control restriction parameter is set as restricted, as described above, the streaming meter device can generate a request for user input in the graphical user interface 220. The request can ask the user whether the network traffic data acquisition parameters 230 should or should not be updated for the target device identifier. For example, the streaming meter device can request the user to confirm whether the “Status” for “00:00:F0:4F:30” should be changed from “Allowed” to “Blocked.” The user can provide the input through the graphical user interface 220, e.g., by interacting with graphical elements of the graphical user interface 220. For example, if the user responds that the “Status” should be changed, the streaming meter device can effect this change in the graphical user interface 220. Obtaining user input in this manner can ensure that there is continuous compliance with consent for monitoring provided by panelists when enrolling into the panel.

FIG. 2C is an illustration of example streaming meter events 270 generated based on network traffic data 280. The first event “Event 1” indicates that, after receiving the parental control restriction data element “BLOCKED” for a device represented by the device identifier “00:00:F0:4F:30” at a time 09:08:00, the streaming meter device received a low bandwidth network parameter “LBW” at a time 09:09:38 within a threshold amount of time from 09:08:00, indicating that no streaming of media content requested following the request for media content and that, therefore, a parental control restriction may be active. The second event “Event 2” indicates that even though the parental control restriction data element “BLOCKED” was received, this was nevertheless followed by a high bandwidth network parameter “HBW” indicating that the streaming of media content occurred despite the parental control restriction data element. In such cases, the acquisition system can generate a data acquisition policy that configures the streaming device such that it refrains from collecting network traffic data for the device represented by “00:00:F0:4F:30” out of caution and ensuring compliance with monitoring regulations. The third event “Event_3” indicates that, after receiving the parental control restriction data element “ALLOWED” the streaming meter device received a high bandwidth network parameter “HBW” indicating streaming activity. In such cases, the acquisition system can generate a data acquisition policy that configures the streaming device such that it once again begins collecting network traffic data for the device represented by “00:00:F0:4F:30.”

An example method for updating network traffic data acquisition parameters 230 of the streaming meter device is described in more detail next.

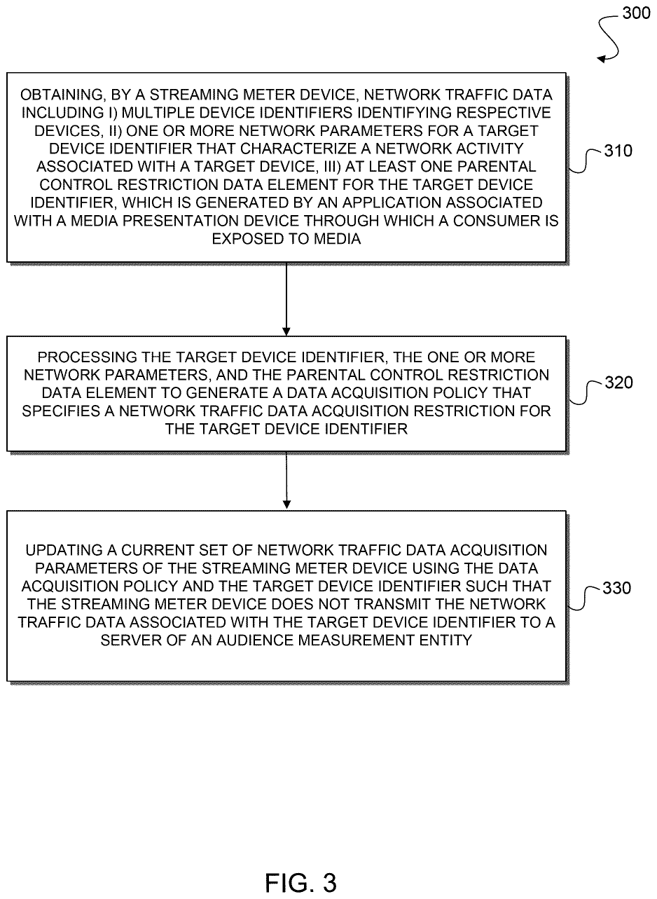

FIG. 3 is a flow chart of an example method 300. Method 300 can be carried out by a system of one or more computers located in one or more locations. For example, any number and combination of acquisition system components described above with reference to FIG. 1A and FIG. 1B, appropriately programmed in accordance with the specification, can perform method 300.

At block 310, method 300 includes obtaining, by the streaming meter device via a network, network traffic data including: multiple device identifiers identifying respective devices associated with the media exposure measurement location, each device of the respective devices configured to stream media via the network, one or more network parameters for a target device identifier of multiple device identifiers, where the one or more network parameters characterize a network activity associated with a target device identified by the target device identifier, and at least one parental control restriction data element for the target device identifier, where the at least one parental control restriction data element is generated by an application associated with the media presentation device through which the consumer is exposed to media.

In one example, the application is installed on the media presentation device and configured to implement parental control restrictions associated with network activity of the media presentation device. In another example, the application is associated with a streaming service provider of the media that the consumer is exposed to through the media presentation device, and wherein the application is configured to set parental control restrictions for a user profile of the consumer on the application. In some cases, the one or more network parameters include a high bandwidth network traffic parameter associated with streaming network activity of the target device and a low bandwidth network traffic parameter associated with non-streaming network activity of the target device. In some cases, the at least one parental control restriction data element specifies a media rating of the media above or below which streaming of the media is restricted and a time period during which the streaming of the media is restricted.

At block 320, method 300 includes processing the target device identifier, the one or more network parameters, and the at least one parental control restriction data element to generate a data acquisition policy that specifies a network traffic data acquisition restriction for the target device identifier. For example, processing the target device identifier, the one or more network parameters, and the at least one parental control restriction data element to generate the data acquisition policy can include: determining that the one or more network parameters comprise a low bandwidth network traffic parameter associated with non-streaming network activity of the target device, wherein the low bandwidth network traffic parameter is associated with a first time stamp that represents a time within a threshold time period after a time represented by a second time stamp associated with the at least one parental control restriction data element.

At block 330, method 300 includes updating a current set of network traffic data acquisition parameters of the streaming meter device using the data acquisition policy and the target device identifier such that the streaming meter device does not transmit the network traffic data associated with the target device identifier to a server of the audience measurement entity.

In some implementations, method 300 further includes generating a streaming meter device event indicating that the network traffic data associated with the target device identifier is being blocked due to parental control restrictions, and transmitting, by the streaming meter device via the network, the streaming meter device event to the server of the audience measurement entity.

In some implementations, method 300 further includes: after updating the current set of network traffic data acquisition parameters of the streaming meter device, blocking collection, by the streaming meter device, of network traffic data associated with the target device.

In some implementations, the data acquisition policy is a first data acquisition policy, and method 300 further includes: obtaining a second different parental control restriction data element for the target device identifier, processing the target device identifier, the second different parental control restriction data element, and the first data acquisition policy to generate a second data acquisition policy, and updating the current set of network traffic data acquisition parameters of the streaming meter device using the second data acquisition policy such that the streaming meter device obtains the network traffic data associated with the target device identifier and transmits the network traffic data associated with the target device identifier to a server of the audience measurement entity.

In some implementations, method 300 further includes: generating one or more modified device identifiers based on the target device identifier, and updating the current set of network traffic data acquisition parameters of the streaming meter device using the data acquisition policy and the one or more modified device identifiers such that the streaming meter device obtains network traffic data associated with the one or more modified device identifiers but does not obtain the network traffic data associated with the target device identifier. For example, method 300 can generate the one or more modified device identifiers based on the one or more network parameters for the target device identifier.

In some implementations, method 300 further includes: generating a notification in a graphical user interface of the streaming meter device indicating that the current set of network traffic data acquisition parameters has been updated.

In some implementations, method 300 further includes: transmitting, via the network and to a server of an audience measurement entity, the updated set of network traffic data acquisition parameters.

In some implementations, method 300 further includes: in response to generating the data acquisition policy for the target device identifier, generating a request for user input in a graphical user interface of the streaming meter device, wherein the user input indicates that the current set of network traffic data acquisition parameters should or should not be updated.

In some implementations, method 300 further includes: receiving user input indicating that the current set of network traffic data acquisition parameters should be updated; and in response to the received user input, updating the current set of network traffic data acquisition parameters of the streaming meter device.

### IV. Example Computing Device

Any one or more of the components described above, such as the server 140, can take the form of a computing device, or a computing system that includes one or more computing devices.

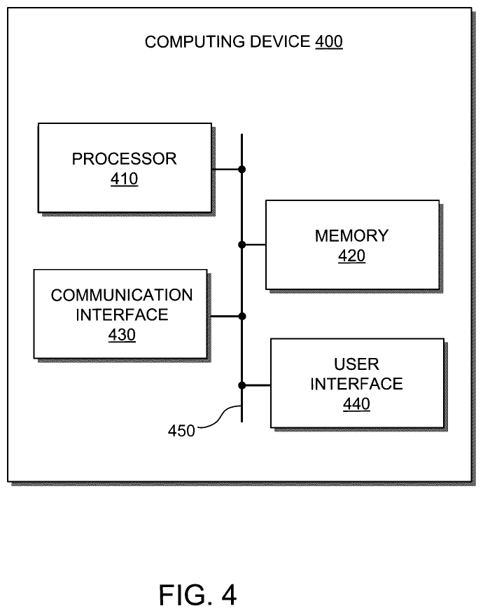

FIG. 4 is a simplified block diagram of an example computing device 400. The computing device 400 can be configured to perform one or more operations, such as the operations described in this disclosure. As shown, the computing device 400 can include various components, such as a processor 410, memory 420, a communication interface 430, and/or a user interface 440. These components can be connected to each other (or to another device, system, or other entity) via a connection mechanism 450.

The processor 410 can include one or more general-purpose processors and/or one or more special-purpose processors.

Memory 420 can include one or more volatile, non-volatile, removable, and/or non-removable storage components, such as magnetic, optical, or flash storage, and/or can be integrated in whole or in part with the processor 410. Further, memory 420 can take the form of a non-transitory computer-readable storage medium, having stored thereon computer-readable program instructions (e.g., compiled or non-compiled program logic and/or machine code) that, upon execution by the processor 410, cause the computing device 400 to perform one or more operations, such as those described in this disclosure. The program instructions can define and/or be part of a discrete software application. In some examples, the computing device 400 can execute the program instructions in response to receiving an input (e.g., via the communication interface 430 and/or the user interface 440). Memory 420 can also store other types of data, such as those types described in this disclosure. In some examples, memory 420 can be implemented using a single physical device, while in other examples, memory 420 can be implemented using two or more physical devices.

The communication interface 430 can include one or more wired interfaces (e.g., an Ethernet interface) or one or more wireless interfaces (e.g., a cellular interface, Wi-Fi interface, or Bluetooth® interface), Such interfaces allow the computing device 400 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 440 can facilitate interaction between computing device 400 and a user of computing device 400, if applicable. As such, the user interface 440 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system, More generally, the user interface 440 can include hardware and/or software components that facilitate interaction between the computing device 400 and the user of the computing device 400.

The connection mechanism 450 can be a cable, system bus, computer network connection, or other form of a wired or wireless connection between components of the computing device 400.

One or more of the components of the computing device 400 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 400 can be combined into a single component, and the function described herein for a single component can be subdivided among multiple components,

### V. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions, However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method for updating network traffic data acquisition parameters of a streaming meter device associated with an audience measurement entity, the streaming meter device disposed at a media exposure measurement location where a consumer is exposed to media through a media presentation device, the method comprising:
obtaining, by the streaming meter device monitoring network traffic passing through a network system at the media exposure measurement location, network traffic data comprising:
i)a plurality of device identifiers identifying respective devices associated with the media exposure measurement location, each device of the respective devices configured to stream media via the network,
ii)one or more network parameters for a target device identifier of the plurality of device identifiers, wherein the one or more network parameters characterize a network activity associated with a target device identified by the target device identifier, and
iii)at least one parental control restriction data element for the target device identifier, wherein the at least one parental control restriction data element characterizes a restriction on streaming of media content to the target device and is generated by an application associated with the media presentation device through which the consumer is exposed to media;
processing the target device identifier, the one or more network parameters, and the at least one parental control restriction data element to generate a data acquisition policy that specifies a network traffic data acquisition restriction for the target device identifier; and
updating a current set of network traffic data acquisition parameters of the streaming meter device using the data acquisition policy and the target device identifier such that the streaming meter device does not transmit the network traffic data associated with the target device identifier to a server of the audience measurement entity.

2. The method of claim 1, wherein the application is installed on the media presentation device and configured to implement parental control restrictions associated with network activity of the media presentation device.

3. The method of claim 1, wherein the application is associated with a streaming service provider of the media that the consumer is exposed to through the media presentation device, and wherein the application is configured to set parental control restrictions for a user profile of the consumer on the application.

4. The method of claim 1, wherein the one or more network parameters comprise a high bandwidth network traffic parameter associated with streaming network activity of the target device and a low bandwidth network traffic parameter associated with non-streaming network activity of the target device.

5. The method of claim 1, wherein processing the target device identifier, the one or more network parameters, and the at least one parental control restriction data element to generate the data acquisition policy comprises:
determining that the one or more network parameters comprise a low bandwidth network traffic parameter associated with non-streaming network activity of the target device, wherein the low bandwidth network traffic parameter is associated with a first time stamp that represents a time within a threshold time period after a time represented by a second time stamp associated with the at least one parental control restriction data element.

6. The method of claim 1, further comprising:
generating a streaming meter device event indicating that the network traffic data associated with the target device identifier is being blocked due to parental control restrictions; and
transmitting, by the streaming meter device via the network, the streaming meter device event to the server of the audience measurement entity.

7. The method of claim 1, further comprising:
after updating the current set of network traffic data acquisition parameters of the streaming meter device, blocking collection, by the streaming meter device, of network traffic data associated with the target device.

8. The method of claim 1, wherein the data acquisition policy is a first data acquisition policy, and wherein the method further comprises:
obtaining a second different parental control restriction data element for the target device identifier;
processing the target device identifier, the second different parental control restriction data element, and the first data acquisition policy to generate a second data acquisition policy; and
updating the current set of network traffic data acquisition parameters of the streaming meter device using the second data acquisition policy such that the streaming meter device obtains the network traffic data associated with the target device identifier and transmits the network traffic data associated with the target device identifier to a server of the audience measurement entity.

9. The method of claim 1, further comprising:
generating one or more modified device identifiers based on the target device identifier; and
updating the current set of network traffic data acquisition parameters of the streaming meter device using the data acquisition policy and the one or more modified device identifiers such that the streaming meter device obtains network traffic data associated with the one or more modified device identifiers but does not obtain the network traffic data associated with the target device identifier.

10. The method of claim 9, wherein generating the one or more modified device identifiers based on the target device identifier comprises:
generating the one or more modified device identifiers based on the one or more network parameters for the target device identifier.

11. The method of claim 1, further comprising:
generating a notification in a graphical user interface of the streaming meter device indicating that the current set of network traffic data acquisition parameters has been updated.

12. The method of claim 1, further comprising:
transmitting, via the network and to a server of an audience measurement entity, the updated set of network traffic data acquisition parameters.

13. The method of claim 1, wherein the at least one parental control restriction data element specifies a media rating of the media above or below which streaming of the media is restricted and a time period during which the streaming of the media is restricted.

14. The method of claim 1, further comprising:
in response to generating the data acquisition policy for the target device identifier, generating a request for user input in a graphical user interface of the streaming meter device, wherein the user input indicates that the current set of network traffic data acquisition parameters should or should not be updated.

15. The method of claim 14, further comprising:
receiving user input indicating that the current set of network traffic data acquisition parameters should be updated; and
in response to the received user input, updating the current set of network traffic data acquisition parameters of the streaming meter device.

16. A system comprising:
at least one processor; and
a memory storing program instructions that, when executed by the at least one processor, cause performance of operations for updating network traffic data acquisition parameters of a streaming meter device associated with an audience measurement entity, the streaming meter device disposed at a media exposure measurement location where a consumer is exposed to media through a media presentation device, the operations comprising:
obtaining, by the streaming meter device monitoring network traffic passing through a network system at the media exposure measurement location, network traffic data comprising:
i)a plurality of device identifiers identifying respective devices associated with the media exposure measurement location, each device of the respective devices configured to stream media via the network,
ii)one or more network parameters for a target device identifier of the plurality of device identifiers, wherein the one or more network parameters characterize a network activity associated with a target device identified by the target device identifier, and
iii)at least one parental control restriction data element for the target device identifier, wherein the at least one parental control restriction data element characterizes a restriction on streaming of media content to the target device and is generated by an application associated with the media presentation device through which the consumer is exposed to media;
processing the target device identifier, the one or more network parameters, and the at least one parental control restriction data element to generate a data acquisition policy that specifies a network traffic data acquisition restriction for the target device identifier; and
updating a current set of network traffic data acquisition parameters of the streaming meter device using the data acquisition policy and the target device identifier such that the streaming meter device does not transmit the network traffic data associated with the target device identifier to a server of the audience measurement entity.

17. The system of claim 16, wherein the application is installed on the media presentation device and configured to implement parental control restrictions associated with network activity of the media presentation device.

18. The system of claim 16, wherein the application is associated with a streaming service provider of the media that the consumer is exposed to through the media presentation device, and wherein the application is configured to set parental control restrictions for a user profile of the consumer on the application.

19. The system of claim 16, wherein the one or more network parameters comprise a high bandwidth network traffic parameter associated with streaming network activity of the target device and a low bandwidth network traffic parameter associated with non-streaming network activity of the target device.

20. A non-transitory computer-readable storage medium storing program instructions that, when executed by at least one processor cause performance of operations for updating network traffic data acquisition parameters of a streaming meter device associated with an audience measurement entity, the streaming meter device disposed at a media exposure measurement location where a consumer is exposed to media through a media presentation device, the operations comprising:
obtaining, by the streaming meter device monitoring network traffic passing through a network system at the media exposure measurement location, network traffic data comprising:
i)a plurality of device identifiers identifying respective devices associated with the media exposure measurement location, each device of the respective devices configured to stream media via the network,
ii)one or more network parameters for a target device identifier of the plurality of device identifiers, wherein the one or more network parameters characterize a network activity associated with a target device identified by the target device identifier, and
iii)at least one parental control restriction data element for the target device identifier, wherein the at least one parental control restriction data element characterizes a restriction on streaming of media content to the target device and is generated by an application associated with the media presentation device through which the consumer is exposed to media;
processing the target device identifier, the one or more network parameters, and the at least one parental control restriction data element to generate a data acquisition policy that specifies a network traffic data acquisition restriction for the target device identifier; and
updating a current set of network traffic data acquisition parameters of the streaming meter device using the data acquisition policy and the target device identifier such that the streaming meter device does not transmit the network traffic data associated with the target device identifier to a server of the audience measurement entity.
